(19) United States
(12) Patent Application Publication
(10) Pub. No.: US 2003/0107639 A1
(43) Pub. Date: Jun. 12, 2003

(54) Process for printing a fluorescent security feature on identification cards and cards produced therefrom

(76) Inventor: Gary Field, Portsmouth, RI (US)

Correspondence Address: BARLOW, JOSEPHS & HOLMES, LTD., 101 DYER STREET, 5TH FLOOR, PROVIDENCE, RI, 02903, US

(21) Appl. No.: 10/316,565

(22) Filed: Dec. 11, 2002

Related U.S. Application Data
(60) Provisional application No. 60/339,176, filed on Dec. 11, 2001.

(51) Int. Cl. B41J 2/17

(52) U.S. Cl. 347/105; 347/98

(57) ABSTRACT

A thermal transfer printing process for making identification cards is provided. The process involves printing indicia onto a dye-receptive surface of a card substrate. The indicia is printed in a processed color generated from a combination of yellow, magenta, and cyan dyes. An overlay coating is applied in precise registration with selected print indicia to form indicia having latent fluorescent properties. The printed indicia is visible in ordinary light and exhibits a bright, distinctive fluorescent glow when irradiated with ultraviolet light (black light). The invention also includes the identification cards produced by this process. The process can be used to produce cards such as licenses, employee badges, student cards, bank cards, and the like having unique security features.

### CROSS-REFERENCE TO RELATED APPLICATIONS

This application claims the benefit of U.S. Provisional Application No. 60/339,176 having a filing date of Dec. 11, 2001.

### BACKGROUND OF THE INVENTION

The present invention generally relates to a process for printing identification cards such as driver's licenses and credit cards. Particularly, the invention involves using a thermal transfer printing process to produce a latent fluorescent security feature on a selected area or printed feature of the card. The invention also encompasses identification cards produced by this process.

In recent years, various agencies have issued more identification cards such as passports, visas, driver's licenses, credit cards, bank cards, security access cards, and the like. Along with the increased circulation of valid identification cards, there has been an increase in card tampering and forgery. These counterfeiting activities are sophisticated and it has become more difficult to detect falsified cards. The industry has attempted to address this problem by manufacturing new tamper-resistant cards in a number of ways.

For example, Onishi et al., U.S. Pat. No. 6,368,684 discloses a method for forming fluorescent latent images on receiving materials such as card substrates. The method involves producing a transfer film having a fluorescent ink layer on its surface. The fluorescent ink layer comprises a resin binder and fluorescent agent. The fluorescent ink layer is brought into contact with a card substrate, and a fluorescent latent image is transferred onto the card by heating the back side of the transfer film using a thermal head or laser as the heating means. The fluorescent image cannot be seen through visible rays, but the image can be seen when it is irradiated with ultraviolet rays. Using this fluorescent image as a security feature, it can be determined whether or not the card is authentic or a false copy. The card can also be printed with a visible image using common thermal dye sublimation and/or heat fusible ink layers. A scratch-resistant, protective polymer coating can be applied over the fluorescent and visible images to protect the surface of the card.

Dyball, U.S. Pat. No. 5,992,891 discloses a method for making identification cards having a security feature. The method involves coating a metallic, vinyl, polyester, or other polymeric material with a first layer containing a dye that will glow at a determined wavelength when the dye is exposed to long wave ultraviolet light (black light). A second layer containing a dye that will glow at a second determined wavelength is coated onto the first layer. For example, the first coating may glow red, and the second coating may glow blue when exposed to black light. A dye diffusion/thermal transfer printer can be used to print the image on the second coating layer. Then, a clear protective coating can be applied over the second coating to protect the surface of the card.

Other methods used to prevent tampering of identification cards do not employ fluorescent images. For example, Huang, U.S. Pat. No. 5,999,280 discloses a holographic anti-imitation device comprising a hologram. A synthesized image is formed in the hologram. The synthesized image has a background pattern visible to naked eyes and a hidden pattern merged into the background that is not visible to naked eyes.

Dell'olmo, U.S. Pat. No. 5,873,305 discloses a method for protecting pre-printed sheets of paper (for example, leaflets, stock certificates, and bank notes) by impressing microengravings on all or some of the printed portions of the paper. The microengravings correspond to holograms or diffraction patterns and are produced by a hot embossing process. The microengravings remain permanently retained on the pre-printed portion of the document after the document has been cooled.

Chatwin et al., U.S. Pat. No. 5,492,370 discloses a method for making a security article such as passports, visas, vehicle license certificates, vehicle tax certificates, identity cards, and the like. The article comprises a plastic substrate having embossed sections that provide a holographic effect. A thin metallic coating is applied over the entire surface of the substrate. An indicia-receptive coating is applied over the non-embossed sections of the substrate so that at least part of the holographic effect remains visible. The coating is printed with security indicia. A protective transparent lacquer then may be coated on the surface of the article.

Other card-issuing agencies apply a transparent coating over the entire surface of the card to deter forgery and assist in detecting counterfeit cards. For example, identification cards are often printed using a thermal transfer dye-sublimation process. Three printing passes are used to apply three colored dyes, yellow, magenta, and cyan, in a specific pattern and print information on the surface of the card. A fourth pass applies a transparent coating that overlays the entire surface of the card. This clear outer coating is a protective coating that helps prevent tampering of the printed information on the card. The coating provides the card with a durable and scratch-resistant finish. A security watermark can be applied on the protective coating in a random or predetermined pattern. For example, a state agency may issue a driver's license with the name of the state printed in a repeating pattern on the clear protective coating in such a manner that the printed information beneath the protective coating remains visible.

Although the foregoing systems may be somewhat effective in manufacturing tamper-resistant identification cards, there is a need for an improved system. It would be desirable to have a process that does not require complex multiple steps or special processing such as the holographic embossing of a material's surface. There is a need for a relatively simple process that a card-issuing agency can use at the time and place where the card is issued. The present invention provides such a process. The invention also encompasses the identification cards produced by the process.

### SUMMARY OF THE INVENTION

The present invention relates to a process for thermal transfer printing an identification card. The process comprises the steps of: a) providing a card substrate having a thermal transfer dye-receptive surface; b) providing a set thermal dye transfer panels effective for printing processed color indicia on the card substrate, and which exhibit a latent fluorescent property when printed in combination with a transparent overlay; c) selectively printing indicia onto the dye-receptive surface, said indicia being printed in a processed color achieved from a combination of at least two dyes selected from the group consisting of yellow, magenta, and cyan dyes; and d) selectively printing the transparent overlay in exact pixel-by-pixel registration with at least one portion of the printed indicia to provide the selected portion of the indicia with the latent fluorescent properties.

The selected portion of the process color printed indicia is visible in ordinary light and also exhibits a distinctive fluorescent glow when irradiated with ultraviolet light (“black light”).

The card substrate may be in the form of a sheet, film, continuous web, individual card or other material suitable for continuous printing processes. Suitable substrate materials include, for example, polyesters, vinyls, polyamides, polyolefins, polyacrylates, polyimides, polystyrenes, polysulfones, aramids, polycarbonates, and celluloses. The card substrate may be coated with a dye-receptive coating comprising a polymer selected from the group consisting of polyesters, vinyls, polyamides, polyolefins, polyacrylates, polyimides, polystyrenes, polycarbonates, celluloses, and mixtures thereof.

Preferably, the processed color of the printed indicia is black and obtained from a combination of yellow, magenta, and cyan dyes. Other dye combinations such as yellow/magenta, yellow/cyan, and magenta/cyan may be used to generate the processed color.

This invention also encompasses identification cards produced by the above-described process. For example, licenses and credit cards having selected printed indicia with a latent fluorescent properties may be produced by this process.

It is noted that the preferred embodiment takes advantage of a natural latent fluorescent property exhibited by the combination of the process color and the clear overlay, and selected registration of the clear overlay so that only a selected portion of the indicia is provided with the fluorescent property. This selected printing feature is important because it requires a highly accurate and expensive print engine to accurately align the pixels to achieve the desired effect without ghosting and fuzzy edge artifacts. In keeping with the intended concept of the invention, i.e. highly accurate pixel-by-pixel registration of process color printing and a clear overlay, it is also contemplated that the selected portion of the indicia on the card could be printed using a single color (black) or only one color of the process color and a transparent overlay panel having a fluorescent dye therein. Only the selected portion of the indicia would be printed with the fluorescent dye of the overlay. Once again, the intended effect could only be achieved using a highly accurate multiple pass printing mechanism.

While multiple pass printing devices are available on the market, most available devices do not have the same accuracy of registration as would a specialized commercial identification card printer as contemplated in the invention. Printers having substrate transport mechanisms with this type of accuracy are very expensive and usually only available to card issuing authorities through specific vendors.

Other objects, features and advantages of the invention shall become apparent as the description thereof proceeds when considered in connection with the accompanying illustrative drawings.

### BRIEF DESCRIPTION OF THE DRAWINGS

The novel features that are characteristic of the present invention are set forth in the appended claims. However, the preferred embodiments of the invention, together with further objects and attendant advantages, are best understood by reference to the following detailed description taken in connection with the accompanying drawings in which:

FIG. 1 is a planar view of an identification card produced in accordance with the present invention;

FIG. 2 is a planar view of a dye ribbon sheet showing different thermal dye panels used in accordance with the process of the present invention;

FIG. 3 is a cross-sectional view of the dye sheet used in accordance with the process of the present invention;

FIG. 4 is an enlarged view of the selected portion of the card provided with the latent fluorescent feature, showing registration and alignment of the printing on a pixel-by-pixel level;

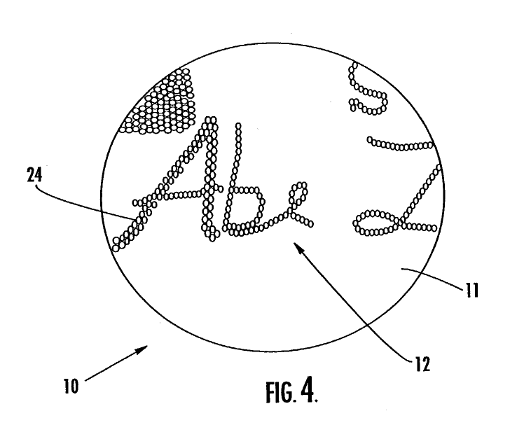

FIG. 5 is an enlarged cross-sectional view of a single printed pixel location showing overlay of the three colors of process printing and a fourth layer of the transparent coating;

FIG. 6a is a top view of a single printed pixel showing the proposed overlapping pixel registration in accordance with the present invention;

FIG. 6b is another top view of a single printed pixel showing the results of improper registration and the ghosting effect created around the peripheral edge thereof; and

FIG. 7 is an enlarged cross-sectional view of a single printed pixel location showing overlay of a single monochrome color and a second layer of the transparent coating having a fluorescent dye.

### DETAILED DESCRIPTION OF THE PREFERRED EMBODIMENTS

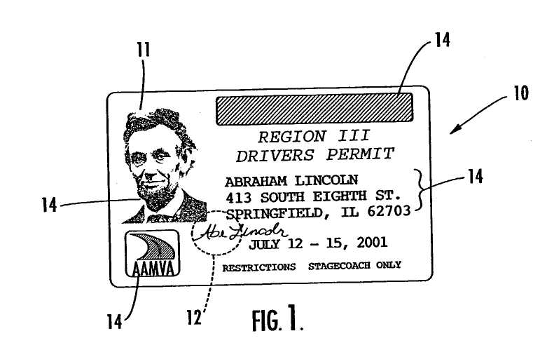

The present invention relates to a thermal transfer printing process for printing indicia on a substrate to form an identification card, and further relates to the resulting identification card as generally indicated at 10 in FIG. 1.

The printing process is a thermal dye sublimation printing process wherein thermal transfer dyes are printed onto a card substrate 11 to provide selected indicia 12 on the card substrate with a latent fluorescent property while the remaining indicia 14 is not provided with the fluorescent property.

By the term, “identification card”, it means any card-like means used to record or display information such as, for example, passports, visas, drivers licenses, employee badges, student cards, credit cards, bank cards, security access cards, and the like.

By the term, “indicia”, it is meant any distinctive mark printed onto a card substrate, such indicia including, but not being limited to, alphabetic letters, numbers, symbols, patterns, lines, geometric shapes, images (for example, photographs), and any other characters.

In general, thermal transfer printing refers to a printing process, wherein thermally-transferable dyes are transferred from a dye sheet, generally indicated at 16 to a dye-receiving material (card substrate) 11, using a heating means (thermal printing head). The thermal dye is transferred to and absorbed by the card substrate 11 via a diffusion mechanism.

Examples of suitable dye-receiving card substrate substrate materials include plain papers, synthetic papers, resin-impregnated papers, and films made from polyesters, vinyls (for example, polyvinyl chloride and polyvinyl acetate), polyamides, polyolefins (for example, polyethylene and polypropylene), polyacrylates, polyimides, polystyrenes, polysulfones, aramids, polycarbonates, celluloses, and other polymers. In the present invention, the dye-receiving card substrate 11 is a PVC plastic material preformed into the shape of a card.

The card substrate 11 may or may not be coated with a dye-receptive coating comprising any suitable resin. For example, polyester, polyamide, polyacrylate, polycarbonate, polyurethane, poly(vinyl acetal), poly(vinyl chloride), and polystyrene resins may be used as well as mixtures thereof.

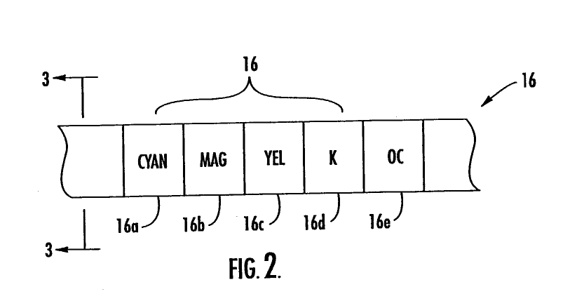

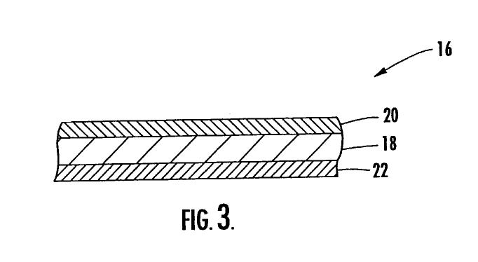

Referring to FIGS. 2 and 3, the dye sheet 16 is preferably in the form of a continuous ribbon with repeating panels of colored dyes (thermal printing ribbon). The ribbon 16 includes a continuous substrate 18, such as a paper or thermoplastic film. The substrate 18 has reasonably good dimensional stability and heat-resistance. Examples of suitable substrate materials for the dye substrate 18 include plain papers, synthetic papers, resin-impregnated papers, and films made from polyesters, vinyls, polystyrenes, polyolefins, polysulfones, aramids, polycarbonates, celluloses, and other polymers.

The dye substrate 18 is coated on its front surface with a transfer dye layer 20 comprising a thermally-transferable dye and binder resin. The preferred dyes for the transfer dye layer 20 are yellow, magenta, and cyan colored dyes. In addition, a transfer dye layer 20 comprising a black dye can be made from a mixture of yellow, magenta, and cyan dyes. Suitable binder resins include, for example, cellulose, vinyl, acrylic, polyurethane, polyamide, and polyester resins. More particularly, ethyl cellulose, ethyl hydroxypropyl cellulose, methyl cellulose, poly(vinyl butyral), poly(vinyl acetal), and poly methacrylate resins can be used. The composition may include releasing agents and other additives.

Still referring to FIGS. 2 and 3, the dye sheet 16 has a continuous ribbon structure, wherein thermal dye panels of different colors, cyan (16a), magenta (16b), yellow (16c), are arranged in a repeating pattern along the length of the sheet. As mentioned above, the dye sheet 16 may optionally contain a black thermal dye panel (16d) for monochrome printing on selected areas of the card 10. The black panel 16d would not be used for any of the fluorescent indicia, as the latent fluorescent phenomenon is only generated with process color printing. The panels 16a-16d may be arranged in an arbitrary order or in a specific sequence that repeats itself along the sheet. Typically, the colors are arranged in a CMYK color pattern as illustrated. Commercially available thermal dye sheets may be used in the present invention. For example, thermal dye sheets (ribbons) from Imperial Chemical Industries (ICI) or Dai Nippon Printing Co. may be used. These thermal dye ribbons contain colored dye panels in various arrangements.

Further in accordance with the present invention, the thermal printing ribbon 16 preferably includes a fifth panel 16e comprising a transparent coating material. The transparent coating 22 preferably comprises a resin selected from the group consisting of polyester, polystyrene, acrylics, polyurethane, polysiloxane, and mixtures thereof. This overlay coating 22 can be applied from a dye sheet panel 16. As shown in FIG. 2, the overlay coating panel 16d may be on the same ribbon dye sheet 10 containing the thermal dye panels 16a, 16b, and 16c.

It is noted that the preferred embodiment takes advantage of a natural latent fluorescent property exhibited by the combination of the process color and the clear overlay, and selected registration of the clear overlay so that only a selected portion of the indicia is provided with the fluorescent property. Latent reflective and absorptive qualities have been previously identified in U.S. Pat. No. 6,303,213 to Berneth, et al. However, the observed effect was only used in a scenario where the entire card was treated with the thermal dyes, i.e. every pixel printed over the surface of the card. In this scenario, all of the process color indicia exhibited a the latent property. In the present invention, only specific pixels are selected for coating, giving the ability to selectively choose which feature is made fluorescent with the coating. This selected printing feature is important because it requires a highly accurate and expensive print engine (card transport mechanism) to accurately align the pixels to achieve the desired effect without ghosting and fuzzy edge artifacts.

Turning back to FIG. 3, the back surface of the dye sheet substrate 12 may also be coated with a back layer 22 to improve substrate feeding and heat-resistance properties. These coatings help prevent the substrate from sticking to a thermal printing head as discussed in further detail below. Suitable resins for the coated back layer 22 include, for example, silicones, fluorocarbons, and acrylics.

In the printing process, selected areas of the dye sheet 16 are heated to transfer the dyes 16a, 16b, 16c, 16d and coating 16e in a desired pattern to the dye-receiving card substrate 11. The pattern is predetermined and based upon electronic signals generated by a device, such as a computer, video camera, electronic still camera, and the like, that are sent to the thermal transfer printing equipment. The dyes 16a, 16b, 16c, and 16d are transferred to the dye-receiving card substrate 11 in a pattern corresponding to the areas of the dye sheet 16 that are heated. More specifically, the thermal print heads used to heat the dye panel 16 are selectively instructed to turn on and off selected “dots” 24 or elements on the print heads to transfer the dye. The result is that the dye is transferred pixel-by-pixel (dot-by-dot) onto the card substrate 11. Arrangement of the pixels 24 and color combinations determines the color and shape of the “indicia” visible on the card substrate 11.

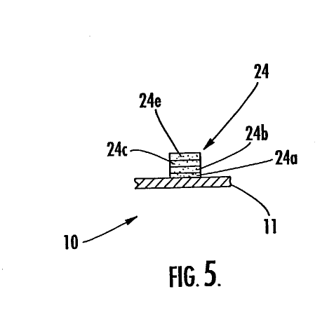

As discussed hereinabove, many agencies issue identification cards using a high quality “three pass” color thermal printing process to generate processed color prints on the card substrate. This process allows card issuing authorities to issue full process color cards over-the-counter. During the printing process, a first thermal dye panel 16a is placed against the card substrate and passed over the thermal printing heads as the card substrate 11 is advanced. This heating action transfers the thermal dye from the panel 16a to produce a first colored print layer 24a on the card substrate 11. Other thermal dye panels 16b and 16c are applied in subsequent passes to produce print layers 24b and 24c and the desired full-color print. For example, cyan (16a), magenta (16b), and yellow (16c) thermal dyes may be applied to the card substrate in three consecutive passes to form a processed color print (See FIG. 5).

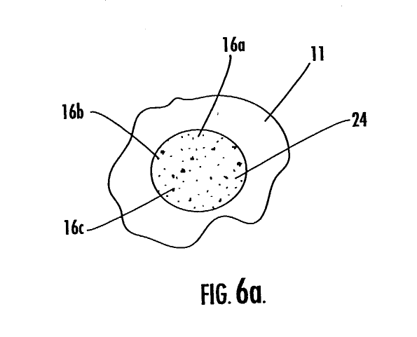

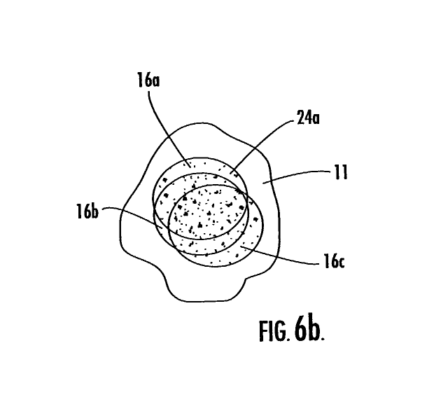

Referring to FIGS. 5-7, there must be highly accurate registration between each pixel 24 printed onto the card in the first pass and each pixel 24 printed thereon in subsequent passes. In other words, each individual pixel of a given color that is printed onto the card in one pass must overlap exactly with a pixel printed onto the card during another pass so that the ultimate processed color does not have fuzzy edges or print artifacts (stray pixels). FIG. 5 is a cross-section of a single pixel showing exact overlapping registration of each pixel 24 printed from each color panel 16. FIG. 6a is a top view of the same pixel 24 having a consistent peripheral edge (full registration). However, FIG. 6b shows a pixel 24a wherein the individual color pixels as printed in each printing pass were not fully registered, causing an uneven peripheral outline (stray artifacts or ghosting depending on the degree of misregistration or colors used).

In the present invention, the thermal printer preferably uses three passes, as described above, to print selected indicia 12, 14 having a distinct processed color on the card substrate 11. In this preferred process, the pixels 24 from each color overlay each other precisely to produce the indicia in a sharply processed color. FIG. 1 shows the identification card 10 printed in full color (color not shown) with selected indicia 12, 14.

To produce the desired latent fluorescent effect on a selected “indicia” of the card, a transparent coating layer 24e is applied in exact pixel-by-pixel registration with a selected printed “indicia” 12 to form a transparent coating layer 24e that precisely overlays the indicia 12. As with the printing passes, the coating layer 24e is transferred in a fourth printing pass. As indicated above, the selective registration of the pixels of the coating layer 24e provides only those selected pixels with the desired fluorescent effect. Designers of the identification card can select which particular feature they desire to be fluorescent, such as for example, the signature of the card holder, as presently shown in the illustrated embodiment. The effect could also be applied to state seals, company names, or any other desired sections of the card that is printed in a processed color in accordance with this invention. Alternatively, the card designer may select an indicia 12 that may be altered to provide readily identify whether the card has been compromised. It is suggested that the birth date of the individual may be the most desirable indicia to provide with the effect as this is the most likely feature of the card to be altered. Physical alteration of the surface of the card would degrade or obliterate the fluorescent effect. Alternatively, the card issuing authority may randomly change the selected indicia at the time of printing so that unsuspecting forgers could not definitively identify which feature was supposed to be fluorescent.

When this clear coating layer 24e is precisely applied over the selected indicia 12, the indicia 12 remains visible under ordinary light. However, when the indicia 12 exhibits a distinctive fluorescent glow when irradiated with ultraviolet light (“black light”). As shown in FIG. 1, the other indicia 14 of the card 10 may be printed in a processed color. However, since these indicia 14 are not coated with a the coating layer 24e, they do not exhibit any fluorescent glow when irradiated with ultraviolet light. As stated above, it is of critical importance that the pixels 24 of the clear overlay coating 24e and printed indicia 24a-24c register and coincide exactly with each other in order to achieve this unique fluorescent effect. There must be precise pixel-by-pixel registration in order for the coating layer 24e to overlay the process color pixels 24e to clearly and distinctly and produce this fluorescent effect.

In the present invention, the thermal dye panels, 16a, 16b, and 16c and the overlay coating panel 16d do not contain any fluorescent dyes or agents. Fluorescent dyes and agents are not responsible for imparting latent fluorescent properties to the printed indicia in the process of this invention. Rather, this unique fluorescent effect is obtained by applying the clear overlay coating layer 24e in precise registration with selected pixels 24 of process color as discussed above.

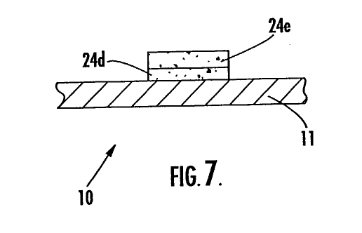

In keeping with the intended concept of the invention, i.e. highly accurate pixel-by-pixel registration of process color printing and a clear overlay, it is also contemplated that the selected indicia 12 on the card could be printed using a single color (black) or only one color of the process color and a transparent overlay panel having a fluorescent dye therein. Referring to FIGS. 2 and 7, the selected indicia could be printed using a single panel of the ribbon, such as any one of the cyan 16a, magenta 16b, yellow 16c, or black 16d panels to create a single print layer 24d (FIG. 7), and then the indicia (print layer 24d) would be overlayed with the transparent coating layer 24e. In this regard, because, the printing process is not using a processed color (three pass), and is using only a monochrome color, the natural fluorescent property is not available. Accordingly, in this embodiment, the transparent overlay panel would have to be provided with a fluorescent dye. However, only the selected portion of the indicia would be printed with the fluorescent dye of the overlay. Once again, the intended effect could only be achieved using a highly accurate multiple pass printing mechanism.

The process of the present invention provides cards having many advantageous features. First, the printed security feature having the latent fluorescent property is not readily detectable. As discussed above, the latent fluorescent printed indicia on the card is completely visible and does not glow under normal lighting conditions. Thus, a person looking at the card ordinarily does not know that it contains a fluorescent security feature unless informed otherwise.

Further, thermal transfer printing is a specialized art that employs complex printing equipment. In the present invention, the indicia must first be printed in a processed color having high resolution and then a clear overlay coating must be applied in exact registration with the selected print indicia. The overlay coating must coincide exactly with the print indicia to obtain a sharp and distinct latent fluorescent effect. A counterfeiter who is not skilled in thermal transfer printing will face multiple difficulties in attempting to duplicate a card having these characteristics.

First, most people do not have access to thermal printing equipment or thermal dye sheets containing overlay coating panels. If a counterfeiter is able to obtain such printing equipment and materials, he or she will need to remove the original overlay coating from a valid card, print new information in a processed color, and apply a new overlay coating in precise registration with the newly printed indicia. Alternatively, a counterfeiter may attempt to produce a completely new card containing falsified information. In either event, the alterations likely will be detectable because of poor registration between the overlay coating and printed indicia. The printed indicia may not glow whatsoever or may provide a fuzzy and blurred glow when exposed to ultraviolet light. Print artifacts (stray pixels) and other print defects will be visible.

Thus, the process of this invention provides identification cards having unique and covert security features that cannot be easily identified or reproduced.

It is appreciated by those skilled in the art that various changes and modifications can be made to the illustrated embodiments without departing from the spirit of the invention. All such modifications and changes are intended to be covered by the appended claims.

What is claimed is:

1. A process for thermal transfer printing an identification card, comprising the steps of:
a) providing a card substrate having a thermal transfer dye-receptive surface;
b) printing indicia onto a selected portion of the dye-receptive surface, said indicia printed in a processed color achieved from a combination of at least two dyes selected from the group consisting of yellow, magenta, and cyan dyes; and
c) applying a transparent overlay coating in registration with the printed indicia to form indicia having latent fluorescent properties.

2. The process of claim 1, wherein the card substrate is in the form of a paper.

3. The process of claim 1, wherein the card substrate is in the form of a film.

4. The process of claim 3, wherein the film comprises a polymer selected from the group consisting of polyesters, vinyls polyamides, polyolefins, polyacrylates, polyimides, polystyrenes, polysulfones, aramids, polycarbonates, and celluloses.

5. The process of claim 1, wherein the surface of the card substrate is coated with a resin selected from the group consisting of polyesters, vinyls, polyamides, polyolefins, polyacrylates, polyimides, polystyrenes, polycarbonates, celluloses, and mixtures thereof.

6. The process of claim 1, wherein the processed color is achieved from a combination of yellow, magenta, and cyan dyes.

7. The process of claim 6, wherein the processed color is black.

8. The process of claim 1, wherein the processed color is achieved from a combination of yellow and magenta dyes.

9. The process of claim 1, wherein the processed color is achieved from a combination of yellow and cyan dyes.

10. The process of claim 1, wherein the processed color is achieved from a combination of magenta and cyan dyes.

11. The process of claim 1, wherein the overlay coating comprises a resin selected from the group consisting of polyester, polystyrene, acrylics, polyurethane, polysiloxane, and mixtures thereof.

12. A process for thermal transfer printing an identification card, comprising the steps of:
a) providing a card substrate having a thermal transfer dye-receptive surface;
b) printing indicia onto a selected portion of the dye-receptive surface, said indicia printed in a processed color achieved from a combination of at least two dyes selected from the group consisting of yellow, magenta, and cyan dyes;
c) applying a transparent overlay coating in registration with the printed indicia to form indicia having latent fluorescent properties; and
d) irradiating the overlay coating and printed indicia with ultraviolet light so that the indicia fluoresces.

13. An identification card having printed indicia with latent fluorescent properties produced by a process, comprising the steps of:
a) thermal transfer printing indicia onto a selected portion of a dye-receptive surface of a card substrate, said indicia printed in a processed color achieved from a combination of at least two dyes selected from the group consisting of yellow, magenta, and cyan dyes; and
b) applying a transparent overlay coating in registration with the printed indicia to form indicia having latent fluorescent properties.

14. The identification card of claim 13, wherein the card is a license.

15. The identification card of claim 13, wherein the card is a credit card.

16. The identification card of claim 13, wherein the processed color is achieved from a combination of yellow, magenta, and cyan dyes.

17. The identification card of claim 16, wherein the processed color is black.

18. The identification card of claim 13, wherein the processed color is achieved from a combination of yellow and magenta dyes.

19. The identification card of claim 13, wherein the processed color is achieved from a combination of yellow and cyan dyes.

20. The identification card of claim 13, wherein the processed color is achieved from a combination of magenta and cyan dyes.

21. The identification card of claim 13, wherein the overlay coating comprises a resin selected from the group consisting of polyester, polystyrene, acrylics, polyurethane, polysiloxane, and mixtures thereof.
